(19) United States
(12) Patent Application Publication
(10) Pub. No.: US 2026/0319070 A1
(43) Pub. Date: Oct. 15, 2026

(54) OPTICAL TRANSCEIVER ASSEMBLY FOR LIDAR, LIDAR, AND TERMINAL EQUIPMENT

(71) Applicant: HESAI TECHNOLOGY CO., LTD., Shanghai (CN)

(72) Inventors: Yanwu XU, Shanghai (CN); Na LI, Shanghai (CN); Bao ZHOU, Shanghai (CN); Shaoqing XIANG, Shanghai (CN)

(21) Appl. No.: 19/692,834

(22) Filed: May 29, 2026

Related U.S. Application Data
(63) Continuation of application No. PCT/CN2024/135128, filed on Nov. 28, 2024.

(30) Foreign Application Priority Data
Nov. 29, 2023 (CN) 202311621853.2
Nov. 29, 2023 (CN) 202323245292.9
Nov. 29, 2023 (CN) 202323249062.X

(51) Int. Cl. G01S 7/48; G01S 7/481; G01S 17/06; G01S 17/89; G02B 13/06; H04N 25/702

(52) U.S. Cl. CPC G01S 7/4802; G01S 7/4812; G01S 7/4813; G01S 17/06; G01S 17/89; G02B 13/06; H04N 25/702

(57) ABSTRACT

This disclosure relates to an optical transceiver assembly for a LiDAR, a LiDAR, and terminal equipment. The optical transceiver assembly includes a transmitting end including a transmitter and a transmitting lens, and a receiving end including a receiving lens and a receiver. The transmitter includes a laser configured to transmit a first light beam, and the transmitting lens is configured to shape and guide the first light beam to an external field of view. The receiving end is configured to transmit an echo generated by reflection of the first light beam from an object to the receiver. The receiver includes a detector configured to receive the echo and generate an electrical signal. A ratio of an image height of the transmitting lens to an image height of the receiving lens at a predetermined field of view angle is within a first threshold range.

### CROSS-REFERENCE TO RELATED APPLICATIONS

This application is a continuation application of PCT Application No. PCT/CN2024/135128, filed on Nov. 28, 2024, which claims priorities to Chinese Patent Application Nos. 202311621853.2, 202323245292.9 and 202323249062.X filed on Nov. 29, 2023. The disclosures of the aforementioned applications are hereby incorporated by reference in their entireties.

### TECHNICAL FIELD

This disclosure relates to the field of LiDAR and, in particular, to an optical transceiver assembly for a LiDAR, a LiDAR, and terminal equipment.

### BACKGROUND

A Light Detection and Ranging (“LiDAR”) is a radar system that detects a position, a velocity, and other parameters of an object by emitting a laser beam. This is an advanced detection method that combines laser technologies with optoelectronic detection technologies. The LiDAR is widely used in fields such as autonomous driving, transportation communication, unmanned aerial vehicles, intelligent robots, and resource exploration due to its advantages including high resolution, strong resistance to active jamming, good detection performance, small size, and light weight.

### SUMMARY

Based on a first aspect of this disclosure, an optical transceiver assembly for a LiDAR is provided, including: a transmitting end, including: a transmitter, including a laser, where the transmitter is configured to emit a light beam; and a transmitting lens, configured to shape the light beam and guide the light beam to an external field of view; and a receiving end, including: a receiving lens, configured to transmit an echo generated by reflection of the light beam from an object to a receiver; and a receiver, including multiple detectors, where the receiver is configured to receive the echo and generate an electrical signal; where a ratio of an image height of the transmitting lens and an image height of the receiving lens at a predetermined field angle is within a first threshold range, such that a degree of overlap between a field of view of the laser and a field of view of the detector is greater than a second predetermined threshold.

Optionally, the second predetermined threshold is 50%, 60%, 80%, or 90%.

Optionally, a field of view (“FOV”) angle of the transmitting end is greater than or equal to 140°, a field of view angle of the receiving end is greater than or equal to 140°, a focal length of the transmitting lens is less than or equal to 16 mm, and a focal length of the receiving lens is less than or equal to 16 mm.

Optionally, the transmitting lens includes at least a first meniscus lens located on a light exit side, a concave surface of the first meniscus lens faces the transmitter, and the first meniscus lens has a negative optical power.

Optionally, the receiving lens includes at least a second meniscus lens located on a light incident side, a concave surface of the second meniscus lens faces the receiver, and the second meniscus lens has a negative optical power.

Optionally, at least one of a horizontal field of view angle or a vertical field of view angle at the transmitting end is less than 180°, and at least one of a horizontal field of view or a vertical field of view at the receiving end is less than 180°.

Optionally, the horizontal field of view angle of the transmitting end is greater than 180°, the horizontal field of view angle of the receiving end is greater than 180°, and the transmitting lens and the receiving lens are arranged vertically.

Optionally, the vertical field of view of the transmitting end is greater than 180°, the vertical field of view of the receiving end is greater than 180°, and the transmitting lens and the receiving lens are arranged horizontally.

Optionally, a degree of distortion of the transmitting lens and the receiving lens at an edge of a field is greater than a degree of distortion at a center of the field.

Optionally, the field of view of the transmitting end is greater than or equal to 150°, the field of view of the receiving end is greater than or equal to 150°, and the focal length of the transmitting lens is less than or equal to 10 mm, and the focal length of the receiving lens is less than or equal to 10 mm.

Optionally, the focal length of the transmitting lens is smaller than the focal length of the receiving lens.

Optionally, a size of the transmitter is smaller than a size of the receiver.

Based on a second aspect of this disclosure, an optical transceiver assembly for a LiDAR is provided, including: a transmitter, including a laser, where the transmitter is configured to emit a light beam; a receiver, including a detector, where the receiver is configured to receive an echo of a light beam reflected from an object and generate an electrical signal; a beam splitter, configured to guide and split the light beam and the echo; and a transceiver lens, configured to shape the light beam and guide the light beam to an external field of view, and to transmit the echo to the receiver; where a ratio of an image height of a transmitting optical path to an image height of a receiving optical path of the transceiver lens at a predetermined field angle is within a first threshold range, such that a degree of overlap between a field of view of the laser and a field of view of the detector is greater than a second predetermined threshold.

Optionally, a field of view of the optical transceiver assembly is greater than or equal to 140°, and a focal length of the transceiver lens is less than or equal to 16 mm.

Optionally, the transceiver lens includes at least a meniscus lens, a concave surface of the meniscus lens faces an incident direction of the light beam, and a convex surface of the meniscus lens faces an incident direction of the echo.

Optionally, the field of view of the optical transceiver assembly is greater than or equal to 150°, and the focal length of the transceiver lens is less than or equal to 10 mm.

Based on a third aspect of this disclosure, an optical transceiver assembly for a LiDAR is provided, including: a transmitting end, including: a transmitter, including a laser array configured to emit a light beam; and a transmitting lens; and a receiving end, including: a receiving lens; and a receiver, including a detector array configured to receive an echo; where an angular resolution of a first region of a field of the optical transceiver assembly differs from an angular resolution of a second region of the field of the optical transceiver assembly, and at least one of the transmitting lens and the receiving lens includes a negative meniscus lens.

Optionally, the second region is closer to an edge of the field of the optical transceiver assembly than the first region.

Optionally, a transmitting chip and a receiving chip are provided on a same circuit board.

Optionally, the transmitting lens includes a first negative meniscus lens, and the laser array includes multiple lasers that are distributed uniformly.

Optionally, a concave surface of the first negative meniscus lens faces an incident direction of the light beam.

Optionally, the detector array includes multiple detectors that are distributed non-uniformly along a first direction.

Optionally, the multiple detectors are distributed non-uniformly along a second direction, and the second direction differs from the first direction.

Optionally, a detector density in a third region of the detector array is greater than a detector density in the fourth region of the detector array.

Optionally, the fourth region is closer to an edge of the detector array than the third region.

Optionally, the receiving lens includes a second negative meniscus lens, and the detector array includes multiple detectors that are distributed uniformly.

Optionally, a convex surface of the second negative meniscus lens faces an incident direction of the echo.

Optionally, the laser array includes multiple lasers that are distributed non-uniformly along the first direction.

Optionally, the multiple lasers are distributed non-uniformly along the second direction, and the second direction differs from the first direction.

Optionally, a laser density in a fifth region of the laser array is greater than a laser density in a sixth region of the laser array.

Optionally, the sixth region is closer to the edge of the detector array than the fifth region.

Optionally, a light spot emitted by one laser in the laser array at least partially overlaps with a field of at least one detector in the detector array.

Optionally, the transmitting lens or the receiving lens includes at least one of the following: a wide-angle lens or a fisheye lens.

Optionally, the optical transceiver assembly further includes a homogenizer provided in an optical path of the transmitting end.

Based on a fourth aspect of this disclosure, a LiDAR is provided, including: the optical transceiver assembly described above; and a controller, configured to control the transmitter to emit the light beam, and determine at least one of a distance and a reflectivity of an object based on the echo received by the receiver.

Based on a fifth aspect of this disclosure, terminal equipment is provided, including the LiDAR described above.

### BRIEF DESCRIPTION OF THE DRAWINGS

By describing exemplary embodiments of this disclosure in combination with accompanying drawings, this disclosure can be better understood.

FIG. 1 shows a schematic block diagram of an exemplary optical transceiver assembly for a LiDAR, consistent with some embodiments of this disclosure.

FIG. 2 shows several examples of a laser array that lasers are distributed uniformly, consistent with some embodiments of this disclosure.

FIG. 3 shows several examples of a detector array that detectors are distributed uniformly, consistent with some embodiments of this disclosure.

FIG. 4 shows an example of a transmitter and a receiver, consistent with some embodiments of this disclosure.

FIG. 5 shows another example of a transmitter and a receiver, consistent with some embodiments of this disclosure.

FIG. 6 shows yet another example of a transmitter and a receiver, consistent with some embodiments of this disclosure.

FIG. 7 shows a schematic diagram of a transmitting lens and a receiving lens that are arranged vertically, consistent with some embodiments of this disclosure.

FIG. 8 shows a schematic diagram of a transmitting lens and a receiving lens that are arranged horizontally, consistent with some embodiments of this disclosure.

FIG. 9 shows a schematic diagram of a transmitting end including a meniscus lens, consistent with some embodiments of this disclosure.

FIG. 10 shows a schematic diagram of a receiving end including a meniscus lens, consistent with some embodiments of this disclosure.

FIG. 11 shows a schematic diagram of an exemplary optical transceiver assembly for a LiDAR, consistent with some embodiments of this disclosure.

FIGS. 12 to 14 respectively show several examples of an exemplary optical transceiver assembly in which a transmitting end and a receiving end have different focal lengths, consistent with some embodiments of this disclosure.

FIG. 15 shows a schematic diagram of an exemplary optical transceiver assembly for a LiDAR, consistent with some embodiments of this disclosure.

FIG. 16 shows an exemplary schematic diagram of an optical transceiver assembly having a non-uniform angular resolution.

FIG. 17 shows a schematic diagram of a transmitter including a negative meniscus lens, consistent with some embodiments of this disclosure.

FIG. 18 shows a schematic diagram of a receiver including a negative meniscus lens, consistent with some embodiments of this disclosure.

FIG. 19 shows a schematic diagram of a transmitting chip and a receiving chip provided on a same circuit board, consistent with some embodiments of this disclosure.

FIGS. 20A to 20C show examples of a detector array that detectors are distributed non-uniformly, consistent with some embodiments of this disclosure.

FIGS. 21A to 21C show examples of a laser array that lasers are distributed non-uniformly, consistent with some embodiments of this disclosure.

FIG. 22 shows a schematic block diagram of an exemplary LiDAR, consistent with some embodiments of this disclosure.

### DETAILED DESCRIPTION

Some embodiments of this disclosure will be described below. It should be noted that during description of these embodiments, for a purpose of concise description, it is impossible to provide an exhaustive description of all features of actual embodiments in this disclosure. It should be understood that in an actual implementation process of any embodiment, just like in any engineering or design project, to achieve objectives of developers and meet system-related or business-related limitations, various decisions are often made, which can change from one embodiment to another. In addition, it can also be understood that although efforts made in this development process can be complicated and lengthy, for those of ordinary skilled in the art related to content disclosed in this disclosure, some design, manufacturing or production and other changes based on technical content disclosed in this disclosure are merely conventional technical means and should not be understood as insufficient content of this disclosure.

Unless otherwise defined, technical or scientific terms used in claims and description shall have ordinary meanings as understood by a person having ordinary skill in the art to which this disclosure relates. Words “first,” “second,” and similar words used in the description and the claims of patent application of this disclosure do not indicate any order, quantity, or importance, but are merely used to distinguish different components. Words “one” or “a” and similar words do not indicate a quantity limitation, but rather that there is at least one. Words “including” or “comprising” and similar words mean that elements or objects preceding “including” or “comprising” encompass elements or objects listed following “including” or “comprising” and their equivalents, but do not exclude other elements or objects. Words “connecting” or “connection” and similar words are not limited to physical or mechanical connections, nor are they limited to direct or indirect connections.

In this disclosure, unless otherwise specified, all embodiments and preferred embodiments mentioned in this disclosure can be combined with each other to form new technical solutions. In this disclosure, unless otherwise specified, all technical features and preferred features mentioned in this disclosure can be combined with each other to form new technical solutions.

In this disclosure, terms “or” and “and/or” describe a relationship between related objects, and represent a non-exclusive inclusion. For example, “A and/or B” and “A or B” may include: there exists only “A,” only “B,” and both “A” and “B,” where “A” and “B” can be singular or plural. For another example, “A, B, and/or C” and “A, B, or C” may include: only “A” exists, only “B” exists, only “C” exists, both “A” and “B” exist, both “A” and “C” exist, both “B” and “C” exist, and both “A,” “B,” and “C” exist, where “A,” “B,” and “C” can be singular or plural. In addition, a character “/” in this disclosure represents that there is an “or” relationship between related objects before and after this character. In this disclosure, a term “at least one of A or B” has a same meaning as “A or B” mentioned above. A term “at least one of A, B, or C” has a same meaning as “A, B, or C” mentioned above.

LiDAR (“Light Detection and Ranging”) is a radar system that detects a position, a velocity, and other characteristic parameters of an object by emitting a laser beam. The LiDAR, also known as laser radar or LADAR, emits a light beam (e.g., a laser beam) towards an object, and then compares and processes received reflected light (e.g., an echo) reflected from the object with emitted light to receive information about the object, for example, parameters such as an object distance, an orientation, an altitude, a velocity, an attitude, a shape, or the like. The LiDAR can include a transmitting end and a receiving end. The transmitting end collimates and shapes emitted light from a laser using a transmitting optical system before projecting the emitted light into an external field of view. The receiving end receives an echo signal of the emitted light reflected from an object using a receiving optical system and a detector. The laser can be deployed on a transmitting circuit board or a transmitting chip, and the detector can be deployed on a receiving circuit board or a receiving chip. In this disclosure, the LiDAR can be replaced with other active detection devices that measure the position, the velocity, and other information of the object by emitting an electromagnetic wave to the object and receiving the electromagnetic wave reflected from the object.

In LiDAR technology solutions, a large field of view (“FOV”) can be achieved using methods such as rotation (e.g., motor), scanning (e.g., galvanometer mirror, rotating mirror), and multi-lens stitching. The above solution will increase complexity and costs of the solution. In some embodiments, a lens that expands a field can be configured to increase the field of view of the LiDAR. Such lens is inevitably subject to distortion, resulting in a mismatch between transmission and reception of the LiDAR (e.g., echoes generated by reflection of light emitted by some transmitters by objects cannot return to corresponding receivers). For a LiDAR that uses a highly integrated transmitter chip and a highly integrated receiver chip, uniformly distributed transmitters and receivers are prone to the mismatch between the transmission and the reception due to lens distortion.

This disclosure provides an optical transceiver assembly for a LiDAR, including a transmitting end and a receiving end. The transmitting end includes a transmitter and a transmitting lens. The transmitter includes a laser. The transmitter is configured to emit a first light beam. The transmitting lens is configured to shape the first light beam and guide the first light beam to an external field of view. The receiving end includes a receiving lens and a receiver. The receiving end is configured to transmit an echo generated by reflection of the first light beam from an object to the receiver. The receiver includes a detector. The receiver is configured to receive the echo and generate an electrical signal. A ratio of an image height of the transmitting lens to an image height of the receiving lens at a predetermined field angle is within a first threshold range, such that a degree of overlap between a field of view of the laser and a field of view of the detector is greater than a second predetermined threshold. Multiple lasers in this disclosure may include one or more of a vertical-cavity surface-emitting laser (“VCSEL”), an edge-emitting laser (“EEL”), a distributed feedback laser (“DFB”), a fiber laser, or similar equipment. The transmitter in this disclosure may also include a laser transmitting circuit, or the like. Multiple detectors in this disclosure may include one or more of a single photon avalanche diode (“SPAD”), an avalanche photodiode (“APD”), a silicon photomultiplier (“SiPM”), or similar equipment. The receiver in this disclosure may also include a light detection circuit, or the like.

In the optical transceiver assembly for the LiDAR in this disclosure, the ratio of the image height of the transmitting lens to the image height of the receiving lens at the predetermined field of view angle is within the first threshold range, such that the degree of overlap between the field of view of the laser and the field of view of the detector is greater than the second predetermined threshold. When the transmitter uses uniformly distributed lasers and the receiver uses uniformly distributed detectors, a match between the transmission and reception can be achieved within the predetermined field angle (e.g., an echo generated by reflection of light emitted by the laser from an object can reach the detector).

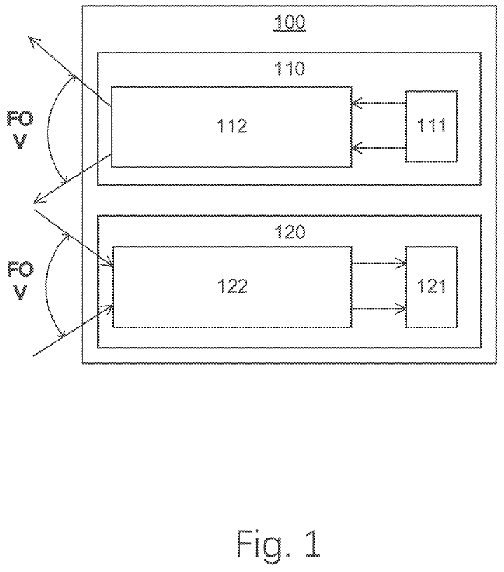

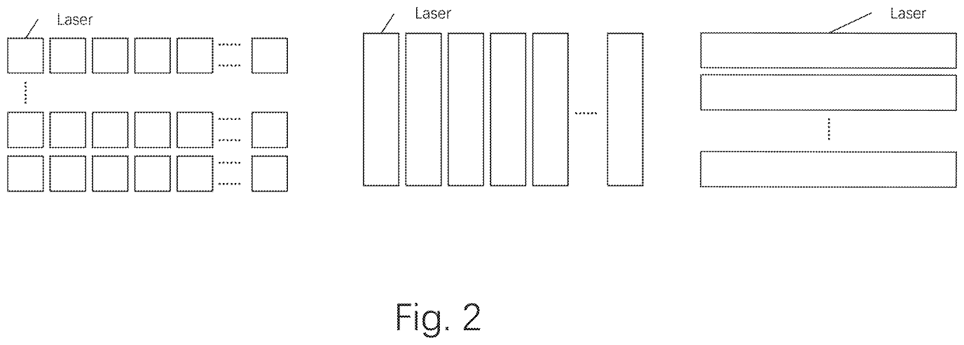

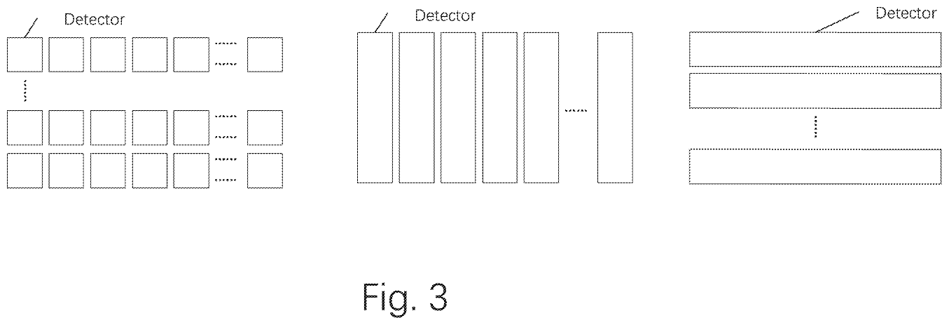

With reference to FIGS. 1 to 3, FIG. 1 shows a schematic block diagram of an exemplary optical transceiver assembly for a LiDAR, consistent with some embodiments of this disclosure. FIG. 2 shows several examples of a laser array that lasers are distributed uniformly, consistent with some embodiments of this disclosure. FIG. 3 shows several examples of a detector array that detectors are distributed uniformly, consistent with some embodiments of this disclosure.

An optical transceiver assembly 100 for a LiDAR includes a transmitting end 110 and a receiving end 120. The transmitting end 110 includes a transmitter 111 and a transmitting lens 112. The transmitter 111 includes a laser that can generate a light beam. The transmitting lens 112 can shape the light beam and guide the light beam to an external field of view. The light beam, shaped and guided by the transmitting lens 112, forms a transmission field of the transmitting end 110 within its detection range in space. The receiving end 120 includes a receiver 121 and a receiving lens 122. The receiving lens 122 can transmit an echo generated by reflection of the light beam from an object to the receiver 121. The receiver 121 includes a detector that can receive the echo and generate an electrical signal. A spatial range that the receiver 121 can detect through the receiving lens 122 forms a reception field of the receiving end 120. The reception field and the transmission field should correspond to each other. For example, a field of view of the laser corresponds to a field of view of the detector, such that an echo generated by the reflection of at least a portion of the light beam emitted by the laser from the object in the space can return to the detector.

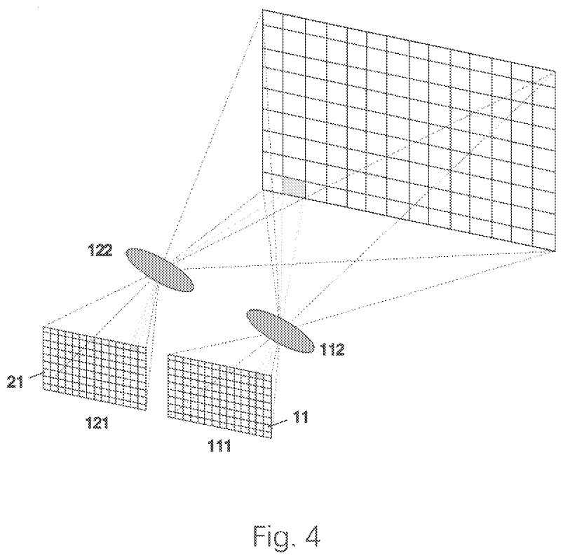

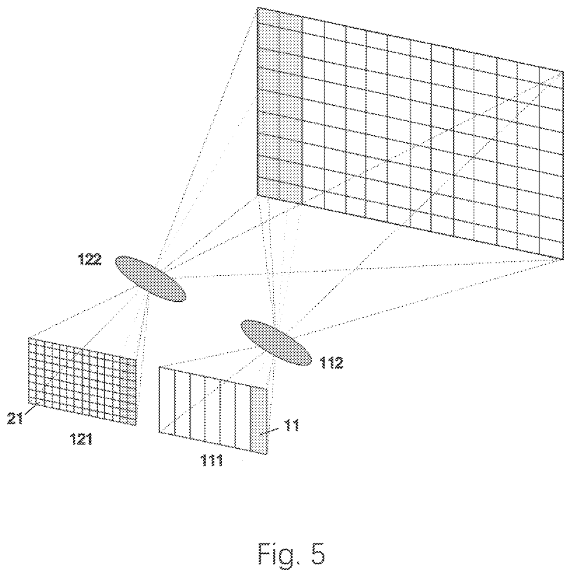

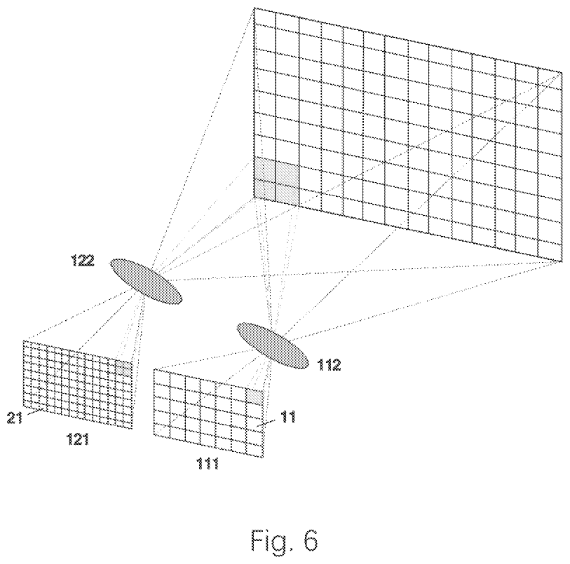

In some embodiments of this disclosure, the transmitter 111 can include a laser array (as shown in FIG. 2), while the receiver 121 can include a detector array (as shown in FIG. 3). The laser array can be a two-dimensionally distributed laser array or a one-dimensionally distributed laser array. Each laser in the laser array can emit light in a time-division manner (e.g., sequentially) or simultaneously. Light beams emitted by lasers in the laser array are collimated and guided by the transmitting lens 112 to form a field of view. Within the field of view, if an object that can reflect the light beam is present, the echo generated by the reflection of the light beam from the object is received by the receiving lens 122, and is converged by the receiving lens 122 onto a corresponding detector of the detector array in a corresponding field, forming a detection loop of the LiDAR. It should be noted that a corresponding relationship between such laser and detector can be that a light spot emitted by the laser 11 corresponds to a field of view of a single detector 21 (as shown in FIG. 4), or a light spot emitted by the laser 11 corresponds to fields of view of the multiple detectors 21 (as shown in FIG. 5 or 6), or light spots emitted by the multiple lasers correspond to a field of view of a single detector, or light spots emitted by the multiple lasers correspond to fields of view of the multiple detectors.

In embodiments of this disclosure, the transmitting lens 112 can expand a transmission field of the transmitter 111. The receiving lens 122 can expand a reception field of the receiver 121. The transmitting lens 112 and receiving lens 122, which can expand the field to increase a field of view of the optical transceiver assembly 100, inevitably bring about pincushion distortion or barrel distortion. Assuming a distortion mismatch between the transmitting lens 112 and the receiving lens 122 (e.g., one lens is distorted while the other is not), the echo generated by the reflection of the light beam emitted by the laser from the object may fail to return to the detector, resulting in a mismatch between a light-emitting surface and a photosensitive surface. As one solution to this problem, a position of the laser or the detector can be adjusted based on distortion to ensure corresponding transmission and reception. For example, assuming that the transmitter 111 has a laser array that lasers are distributed uniformly and the transmitting lens 112 introduces optical distortion, while the distortion of the receiving lens 122 differs significantly from the distortion of the transmitting lens 112, or the transmitting lens 112 has no distortion, then based on specific distortion curves of these two lenses, a detector array on the receiver 121 can be designed that detectors are distributed non-uniformly. This compensates for a mismatch between the light-emitting surface and the photosensitive surface caused by the lens distortion. As a degree of integration of optoelectronic devices increases, such as chipization of the transmitting end and the receiving end, transmitting end/receiving end devices become integrated devices, and the integrated devices may include uniformly distributed transmitting end/receiving end devices. For IC design, uniformly distributed lasers/detectors and processing circuits are more economical and less complex, so alternative solutions are needed to solve this problem.

In some embodiments of this disclosure, the transmitting lens 112 and the receiving lens 122 can be designed to have the same or similar distortion curves, that is, to have the same or similar f-θ (“F-theta”) distortion. The transmitting lens 112 and the receiving lens 122 having the same f-θ distortion means that, at the predetermined field of view angle, the ratio of the image height of the transmitting lens to the image height of the receiving lens is the same or similar, and falls within a first predetermined range. In this way, both the transmitter 111 and the receiver 121 can include uniformly distributed optoelectronic devices, and the field of view of the laser and the field of view of the detector can basically overlap. For detection, it requires that the field of view of the laser and the field of view of the detector overlap, and the degree of overlap is greater than a predetermined threshold. In this case, it does not need the transmitting lens 112 and the receiving lens 122 to have exactly the same f-θ distortion; rather, it suffices that they have the similar distortion. The transmitting lens 112 and the receiving lens 122 having the similar f-θ distortion means that, at the predetermined field of view angle, the ratio of the image height of the transmitting lens to the image height of the receiving lens is within the first threshold range, such that the degree of overlap between the field of view of the laser and the field of view of the detector can be greater than a second predetermined threshold. As an example, the second predetermined threshold can be between 50% and 90%, for example, 50%, 60%, 80%, or 90%. Values of the first threshold range are related to focal lengths of the transmitting lens and the receiving lens.

In some embodiments, a ratio of the image height of the transmitting lens 112 to the image height of the receiving lens 122 at the predetermined field of view angle is within the first threshold range, such that the degree of overlap between the field of view of the laser and the field of view of the detector is greater than the second predetermined threshold.

In some embodiments, a ratio of the image height of the transmitting lens 112 to the image height of the receiving lens 122 at multiple predetermined field of view angles is within the first threshold range, such that the degree of overlap between the field of view of the laser and the field of view of the detector is greater than the second predetermined threshold.

In some embodiments, a ratio of the image height of the transmitting lens 112 to the image height of the receiving lens 122 at each predetermined field of view angle is within the first threshold range, such that the degree of overlap between the field of view of the laser and the field of view of the detector is greater than the second predetermined threshold.

In some embodiments of this disclosure, the focal length of the transmitting lens 112 and the focal length of the receiving lens 122 can be the same or different. The focal lengths can be adjusted based on a size of the transmitter 111 and a size of the receiver 121, as long as the aforementioned transmitting lens 112 and receiving lens 122 can use the same or similar f-θ distortion, such that the degree of overlap between the field of view of the laser and the field of view of the detector can be greater than the second predetermined threshold. For example, the transmitting lens 112 and the receiving lens 122 can use similar design, or the receiving lens (or transmitting lens) can be redesigned based on the existing transmitting lens (or receiving lens), and a f-θ distortion curve of a lens can be adjusted by changing a material, a curvature, a thickness, and a spacing of lenses in the lens to make it the same or similar to a f-θ distortion curve of the transmitting lens (or receiving lens).

In some embodiments of this disclosure, the optical transceiver assembly 100 may use a laser array that lasers are arranged uniformly and a detector array that detectors are arranged uniformly. A size of the laser array and a size of the detector array can be the same or different. For the transmitting lens 112 and the receiving lens 122, their image height h is related to a field of view angle θ, a focal length f, and a f-θ distortion curve. Assuming that the transmitter 111 (or the receiver 121) includes the uniformly distributed lasers (or detectors) and a design of the transmitting lens 112 (or the receiving lens 122) is completed for the desired transmission field (or the reception field), the focal length and the distortion curve of the transmitting lens 112 (or the receiving lens 122) are fixed, and the image height of the corresponding transmitting lens 112 (or the receiving lens 122) at the predetermined field of view angle θ is determined. In this case, to align the field of view of the laser with the field of the corresponding detector, for example, if a laser beam emitted by the laser passes through the transmitting lens 112 and corresponds to a field of view angle θ₀, the echo of the laser beam reflected from the object needs to pass through the receiving lens 122 to reach the corresponding detector. To achieve this, it needs to design the receiving lens 122 (or the transmitting lens 112), such that there is a corresponding relationship between the image height of the laser beam (at an angle of θ₀) at the receiving lens 122 (or transmitting lens 112) and the size of the detector (or the laser). To ensure that the field of view of the laser can be aligned with the field of view of the detector, the ratio of the image height of the transmitting lens 112 to the image height of the receiving lens 122 at the predetermined field of view angle needs to be within the first threshold range. It should be noted that when the ratio of the image height of the transmitting lens 112 to the image height of the receiving lens 122 is equal to a ratio of a size of the laser to a size of the detector, the laser and the detector can be perfectly aligned. However, since both the laser and the detector have certain sizes, it is also acceptable even if they are not perfectly aligned. Accordingly, setting the ratio of the image height of the transmitting lens 112 to the image height of the receiving lens 122 at the predetermined field of view angle within the first threshold range may allow the degree of overlap between the field of view of the laser and the field of view of the detector to be greater than the second predetermined threshold. To achieve the above objective, the receiving lens 122 and the transmitting lens 112 need to have the same or similar f-θ distortion curves. It is possible to align the field of view of the laser with the field of view of the detector, when both the transmitter 111 and the receiver 121 use the uniformly distributed optoelectronic devices (e.g., the lasers and the detectors).

In the embodiments of this disclosure, the transmitting lens 112 can expand the transmission field of the transmitter 111 to make the field of view of the transmitting end 110 greater than or equal to 140°, and the receiving lens 122 can expand the reception field of the receiver 121 to make the field of view of the receiving end 120 greater than or equal to 140°. The focal length of the transmitting lens 112 can be less than or equal to 16 mm. The focal length of the receiving lens 122 can be less than or equal to 16 mm. Compared to using a moving part to rotate the optical transceiver assembly or using a scanning device to change a propagation direction of the light beam to achieve a larger field of view, this disclosure uses a lens that can expand the field of view to replace the moving part or the scanning device to achieve LiDAR with a super large field. This can reduce size requirements for the optoelectronic devices in the LiDAR while expanding the field of view of the LiDAR. In addition, this can also eliminate additional costs caused by the moving part or the scanning device. It should be noted that the field of view of the transmitting end 110 herein is greater than or equal to 140°. It means that at least one of a horizontal field of view and a vertical field of view of the transmitting end 110 is greater than or equal to 140°. The field of view of the receiving end 120 herein is greater than or equal to 140°. It means that at least one of a horizontal field view and a vertical field of view of the receiving end 120 is greater than or equal to 140°.

For the transmitting end (e.g., transmitting end 110) and receiving end (e.g., receiving end 120), their focal length, field of view angle, and device size can be represented by the following formula.

$$\{ \begin{matrix}{f}_{R x} \times {θ}_{R x} = {L}_{R x} \\ {f}_{T x} \times {θ}_{T x} = {L}_{T x}\end{matrix}$$

$${θ}_{T x} = {θ}_{R x}$$

Among them, f_{Rx} is the focal length of the receiving end, f_{Tx} is the focal length of the transmitting end, θ_{Rx} is the field of view angle of the receiving end, θ_{Tx} is the field of view angle of the transmitting end, L_{Rx} is the size of the detector, and L_{Tx} is the size of the laser.

Based on the above formula, it can be seen that when the field of view angle is fixed, the size of the laser or the size of the detector is related to the focal length of the transmitting lens 112 or the focal length of the receiving lens 122. For the receiving end, due to the detector having a certain size and to increase the number of point clouds in one frame of image and improve a resolution, the detector array typically includes many detectors. Accordingly, an overall size of the detector array is relatively large. If the focal length of the transmitting end is the same as the focal length of the receiving end, the size of the laser array at the transmitting end also needs to be larger, which is not conducive to costs and yield control. Accordingly, in some embodiments, the focal length of the transmitting lens 112 can be designed to be smaller than the focal length of the receiving lens 122, thereby reducing the size of the laser array. In such a case, the size of the transmitter 111 can be smaller than the size of the receiver 112.

In some embodiments of this disclosure, the field of view angle of the transmitting end 110 can be greater than or equal to 140° in a first direction, and is not limited in a second direction different from the first direction. In other embodiments of this disclosure, the field of view angle of the transmitting end 110 can also be greater than or equal to 140° in the second direction. As an example, the first direction and the second direction can be a horizontal direction and a vertical direction, respectively.

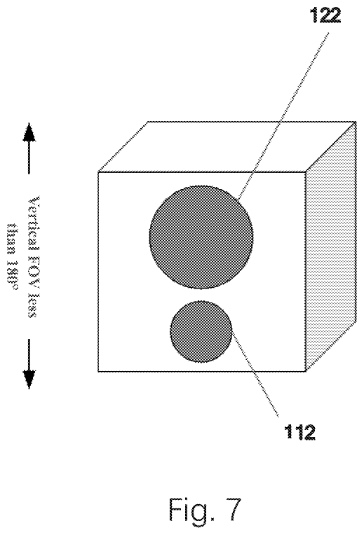

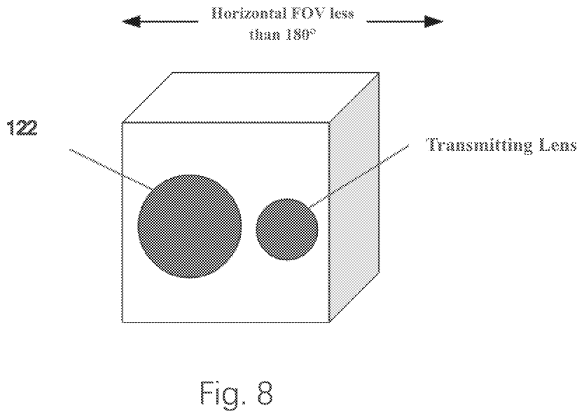

In some embodiments of this disclosure, when the horizontal field of view angle and the vertical field of view angle of the transmitting end 110 are both greater than 140°, considering effective isolation between transmission and reception, at least one of the horizontal field of view and the vertical field of view of the transmitting end 110 needs to be less than 180°. Similarly, when the horizontal field of view angle and the vertical field of view angle of the receiving end 120 are both greater than 140°, at least one of the horizontal field of view angle and the vertical field of view angle of the receiving end 120 needs to be less than 180°. If the horizontal field of view angle of the transmitting end 110 exceeds 180° and the horizontal field of view angle of the receiving end 120 exceeds 180°, the transmitting lens 112 and the receiving lens 122 can be arranged vertically, as shown in FIG. 7. If the vertical field of view angle of the transmitting end 110 exceeds 180° and the vertical field of view angle of the receiving end 120 exceeds 180°, the transmitting lens 112 and the receiving lens 122 can be arranged horizontally, as shown in FIG. 8.

In some embodiments of this disclosure, the transmitting lens 112 can be designed with an all-glass or glass-plastic structure, and the number of lenses typically increases with an increase in the field of view of the lens. The transmitting lens 112 may include a front lens group and a rear lens group. The front lens group can expand the field of view (i.e., compress an object-side large field of view angle to a field range required by an ordinary lens). The rear lens group can shape (e.g., collimate) the laser beam emitted by the transmitter 111. The front lens group and the rear lens group together provide the focal length required by the transmitting lens 112.

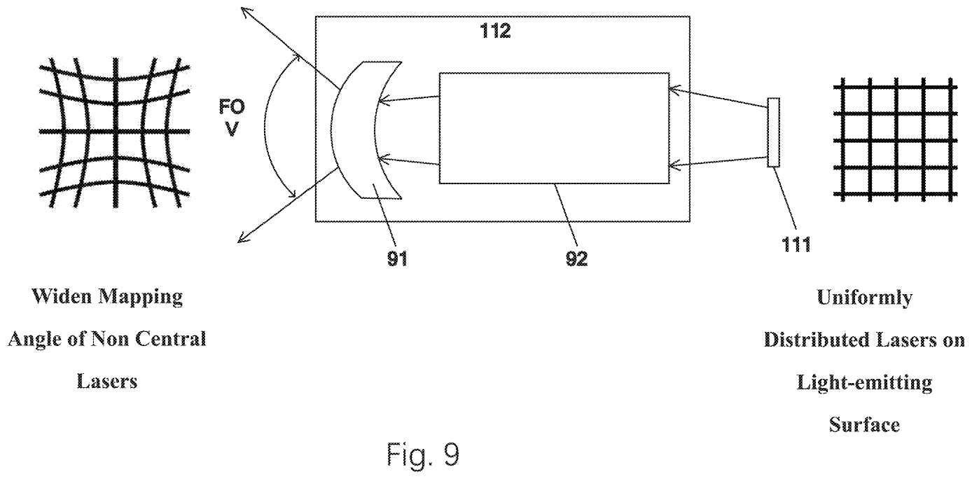

To provide better field compression, that is, to give the transmitting end 110 a larger field of view, the transmitting lens 112 includes at least a first meniscus lens located on a light exit side, as a component in the front lens group. The first meniscus lens can expand the transmission field of the transmitter 111, as shown in FIG. 9. The first meniscus lens 91 can have negative optical power, thereby shortening an overall focal length of the transmitting lens 112. As shown in the figure, the transmitting lens 112 further includes a rear lens group 92. The rear lens group 92 is configured to shape (e.g., collimate) the light beam emitted by the transmitter 111.

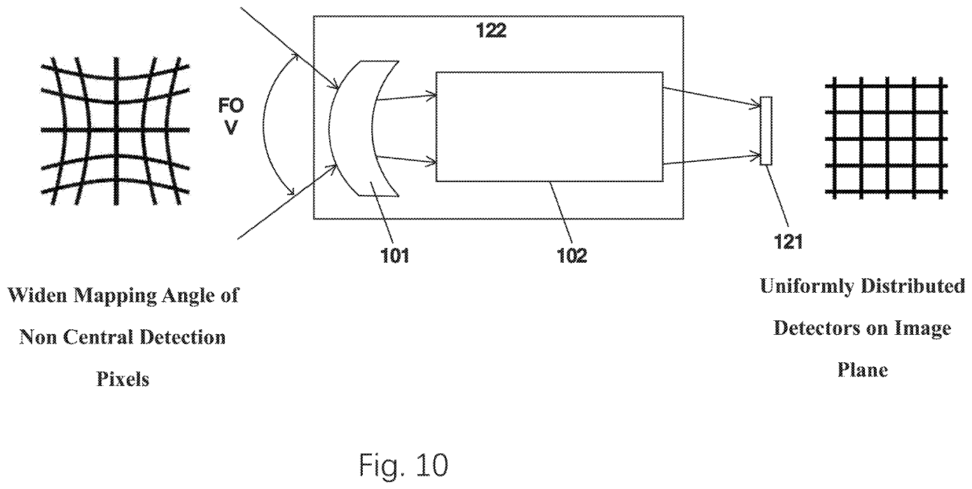

Similarly, to provide the better field compression, that is, to give the receiving end 120 a larger field of view, the receiving lens 122 may include at least a second meniscus lens located on a light incident side, as a component in the front lens group. The second meniscus lens can expand the reception field of the receiver 121, as shown in FIG. 10. The second meniscus lens 101 can have negative optical power, thereby shortening an overall focal length of the receiving lens 122. As shown in the figure, the transmitting lens 112 further includes a rear lens group 102. The rear lens group 102 is configured to guide the echo to the receiver 121.

A relationship between the field of view θ and the image height h of an undistorted lens (focal length f) is h=f*tan(θ), and an angular resolution of a central field of a lens (focal length f) for a single detector of a size x is απx/f. From the above two formulas, it can be seen that with a fixed size of a single detector, if the higher angular resolution (i.e., smaller a value) is desired, the larger focal length f of the lens is better. Under the same field of view, the larger f is, the image height h of an edge of the field of view will increase significantly. That is to say, the required device size will increase accordingly, and an increase in the device size means an increase in costs and a decrease in reliability.

As mentioned above, the transmitting lens 112 and the receiving lens 122 of this disclosure may have the f-θ distortion. By designing the distortion curves of the transmitting lens 112 and the receiving lens 122 properly, a degree of distortion of the transmitting lens 112 and the receiving lens 122 at an edge of the field (corresponding to a larger field of view angle) can be greater than a degree of distortion at a center of the field (corresponding to a smaller angle). In this way, it can quickly converge the image height at an edge of the lens, thereby avoiding the excessive device size while meeting requirements of the angular resolution and the field of view of the central field. It can balance the angular resolution and the device size of the central field.

On the other hand, when the size of the laser and the size of the detector are uniform, and the lasers and the detectors are arranged uniformly, a lens design of this disclosure allows for greater distortion at the edge of the field, thereby reducing the device size. Accordingly, the detector closer to the edge of the field corresponds to a larger field of view angle spacing, that is, its corresponding point cloud is more diluted. However, the LiDAR typically focuses more on a detection situation of the central field, the optical transceiver assembly 100 with a large field of view takes advantage of this aspect, thereby receiving a point cloud that is dense at a central field and sparse at an edge field while maintaining a large field of view. In this way, the angular resolution of a central region of the LiDAR can be higher, thereby providing more precise target recognition and measurement for the central region.

As shown in FIG. 9, the transmitting lens 112 can twist a light-emitting surface that the lasers are distributed uniformly into a surface with a center dense and edge sparse structure. Specifically, a laser at an edge channel can correspond to a larger field of view angle in space, while a laser at a central channel is less affected by the distortion of the transmitting lens 112, and more pixels can be applied to the central field, maintaining a higher pixel density and achieving a relatively high resolution of the central field. In this way, in a case where the size of the laser array in the transmitter 111 is small, the transmitting end 110 can achieve both coverage of a larger field of view and densification of the central field. For example, the size of the laser array can be less than 500 mm², less than 400 mm², less than 300 mm², less than 200 mm², less than 100 mm², or even smaller. Optionally, a concave surface of the first meniscus lens 91 can face the transmitter 111.

As shown in FIG. 10, the receiving lens 122 can twist a photosensitive surface that the detectors are distributed uniformly into a surface with a center dense and edge sparse structure. Specifically, a detector at an edge channel can correspond to a larger field of view angle in space, while a detector at a central channel is less affected by the distortion of the receiving lens 122, and more pixels can be applied to the central field, maintaining a higher pixel density and achieving a relatively high resolution of the central field. In this way, in a case where the size of the detector array in the receiver 121 is small, the receiving end 120 can simultaneously achieve coverage of a larger field of view and densification of the central field. For example, the size of the detector array can be less than 500 mm², less than 400 mm², less than 300 mm², less than 200 mm², less than 100 mm², or even smaller. Optionally, a concave surface of the second meniscus lens 101 can face the receiver 121.

In some embodiments of this disclosure, the transmitting lens 112 can expand the transmission field of view of the transmitter 111 to make the field of view of the transmitting end 110 greater than or equal to 150°, and the receiving lens 122 can expand the reception field of the receiver 121 to make the field of view angle of the receiving end 120 greater than or equal to 150°. Moreover, the focal length of the transmitting lens 112 can be less than or equal to 10 mm, and the focal length of the receiving lens 122 can be less than or equal to 10 mm.

In some embodiments of this disclosure, the transmitting end can use various types of lasers, including but not limited to the vertical cavity surface-emitting laser (“VCSEL”), the edge-emitting laser (“EEL”), or the like. The receiving end can use various types of detectors, including but not limited to the single photon avalanche diode (“SPAD”), the avalanche photodiode (“APD”), the silicon photomultiplier (“SiPM”), or the like.

Based on another exemplary embodiment, this disclosure further provides an optical transceiver assembly for a LiDAR, including: a transmitter, including a laser, where the transmitter is configured to emit a light beam; a receiver, including a detector, where the receiver is configured to receive an echo generated by reflection of the light beam from an object and generate an electrical signal; a beam splitter, configured to guide and split the light beam and the echo; and a transceiver lens, configured to shape the light beam and guide the light beam to an external field of view, and to transmit the echo to the receiver; where a ratio of an image height of a transmitting optical path to an image height of a receiving optical path of the transceiver lens at a predetermined field of view angle is within a first threshold range, such that a degree of overlap between a field of view of the laser and a field of view of the detector is greater than a second predetermined threshold. The image height of the transmitting optical path may refer to a distance between a center of a laser emitting a light beam with a certain field of view angle and a principal optical axis of the transmitting optical path. The image height of the receiving optical path may refer to a distance between a center of a detector receiving an echo with a certain field of view angle and a principal optical axis of the receiving optical path. Among them, since a beam splitter can guide and split the light beam and the echo, it may cause the transmitting optical path or the receiving optical path to be deflected. Accordingly, if the transmitting optical path (or the receiving optical path) is deflected by the beam splitter, the aforementioned principal optical axis can be a principal optical axis of a transmitting optical path (or a receiving optical path) that has been deflected. If the transmitting optical path (or the receiving optical path) is not deflected by the beam splitter, the aforementioned principal optical axis can be a principal optical axis of a transmitting optical path (or a receiving optical path) that has not been deflected.

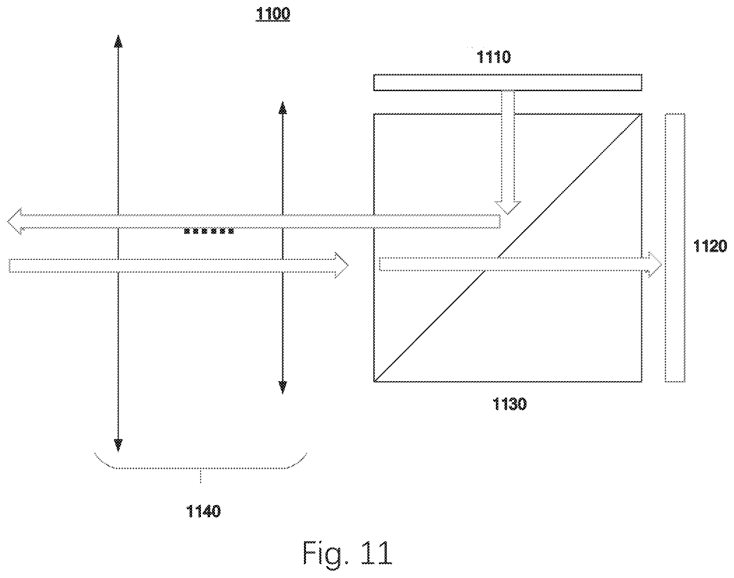

FIG. 11 shows a schematic diagram of an exemplary optical transceiver assembly for a LiDAR, consistent with some embodiments of this disclosure. Several details of an optical transceiver assembly 1100 are the same as those of the optical transceiver assembly 100 described above with respect to FIGS. 1 to 10, and will not be repeated herein. The following mainly describes differences of the optical transceiver assembly 1100.

The optical transceiver assembly 1100 for the LiDAR may include a transmitter 1110, a receiver 1120, a beam splitter 1130, and a transceiver lens 1140. The transmitter 1110 includes a laser that can emit a light beam. The receiver 1120 includes a detector. The receiver can receive an echo generated by reflection of the light beam from an object and generate an electrical signal.

Compared with the optical transceiver assembly 100 with an off-axis optical path, the optical transceiver assembly 1100 has a coaxial optical path, and its transmitting optical path and receiving optical path at least overlap partially. In some embodiments, the optical transceiver assembly 1100 includes the beam splitter 1130, and the transceiver lens 1140 that serves as a transmitting optical path lens and a receiving optical path lens. The beam splitter 1130 can guide and split the light beam and the echo. After the light beam is shaped and guided by the transceiver lens 1140, its detection range in the space forms a transmission field of the optical transceiver assembly 1100. A spatial range detectable by the receiver 1120 through the transceiver lens 1140 forms a reception field of the optical transceiver assembly 1100. As shown in FIG. 11, the beam splitter 1130 can reflect at least a portion of a light beam emitted by the transmitter 1110 to the transceiver lens 1140. The transceiver lens 1140 can shape the light beam and guide the light beam to an external field of view. The transceiver lens 1140 can also guide the echo of the light beam reflected from the object to the beam splitter 1130. The beam splitter 1130 can transmit at least a portion of the echo to transmit it to the receiver 1120. It should be noted that in some embodiments, positions of the transmitter 1110 and the receiver 1120 can also be interchanged, and in this case, the beam splitter 1130 can transmit at least a portion of the light beam emitted by the transmitter 1110 to transmit it to the transceiver lens 1140, and can reflect at least a portion of the echo and transmit it to the receiver 1120.

In the optical transceiver assembly 1100, the transmitter 1110 and the receiver 1210 of the optical transceiver assembly 1100 can use the uniformly distributed optoelectronic devices (such as the lasers and the detectors). In some embodiments of this disclosure, the transmitting end and the receiving end may use the same transceiver lens 1140 (as shown in FIG. 11). The focal length of the transmitting end and the focal length of the receiving end are the same. Therefore, the size of the transmitter 1110 can match the size of the receiver 1120 to ensure that the degree of overlap between the field of view of the laser and the field of view of the detector is greater than the second predetermined threshold. It achieves alignment of the field of view of the laser with the field of view of the detector. As an example, the second predetermined threshold can be between 50% and 90%, for example, 50%, 60%, 80%, or 90%.

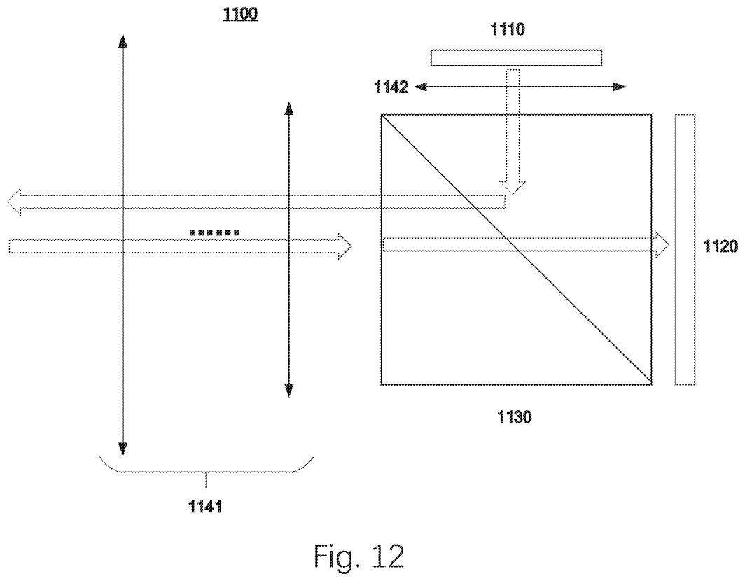

In some embodiments of this disclosure, the transmitting end and the receiving end of the optical transceiver assembly 1100 may also have different focal lengths. With reference to FIGS. 12 to 14, several examples are shown where the transmitting end and the receiving end of the optical transceiver assembly 1100 have different focal lengths.

As shown in FIG. 12, the transceiver lens may include a first lens 1141 and a second lens 1142. The first lens 1141 can serve as a common lens for both the transmitting optical path and the receiving optical path, while the second lens 1142 can serve as a dedicated lens for the transmitting optical path. In this case, the first lens 1141 and the second lens 1142 form the transmitting optical path lens, while the first lens 1141 forms the receiving optical path lens.

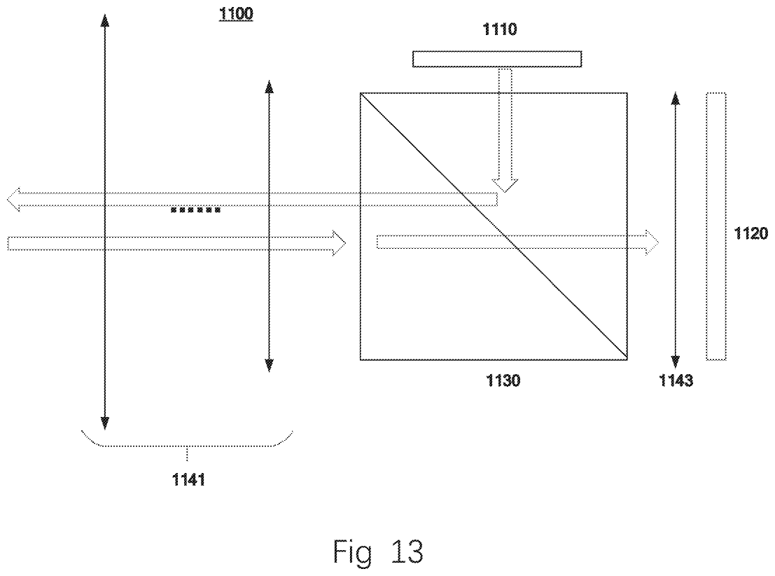

As shown in FIG. 13, the transceiver lens may include the first lens 1141 and a third lens 1143. The first lens 1141 can serve as the common lens for both the transmitting optical path and the receiving optical path, while the third lens 1143 can serve as a dedicated lens for the receiving optical path. In this case, the first lens 1141 forms the transmitting optical path lens, while the first lens 1141 and the third lens 1143 form the receiving optical path lens.

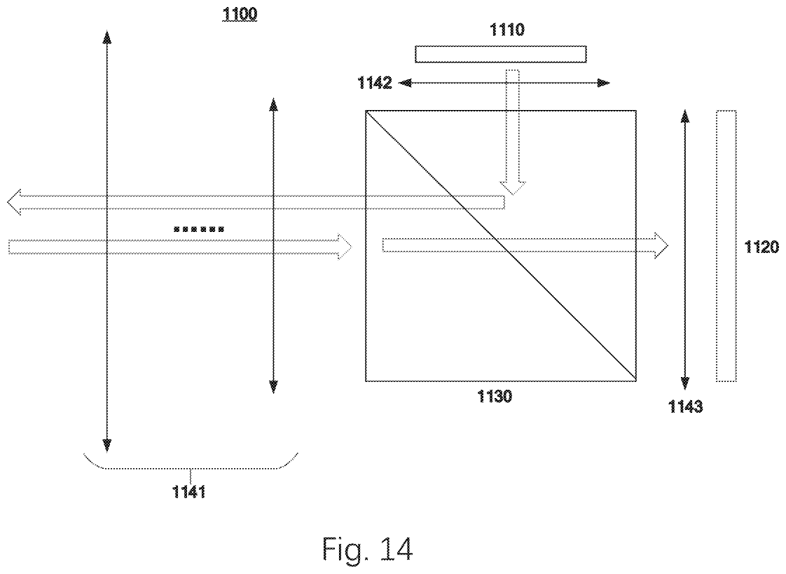

As shown in FIG. 14, the transceiver lens may include the first lens 1141, the second lens 1142, and the third lens 1143. The first lens 1141 can serve as the common lens for both the transmitting optical lens and the receiving optical path, the second lens 1142 can serve as the dedicated lens for the transmitting optical path, and the third lens 1143 can serve as the dedicated lens for the receiving optical path. In this case, the first lens 1141 and the second lens 1142 form the transmitting optical path lens, while the first lens 1141 and the third lens 1143 form the receiving optical path lens.

In the above embodiments, since the transmitting optical path and the receiving optical path are composed of different lenses, a distortion mismatch may occur. This could cause the echo generated by the reflection of the light beam emitted by the laser from the object to fail to return to the detector, that is, a mismatch occurs between the light-emitting surface and the photosensitive surface. In this regard, the ratio of the image height of the transmitting optical path to the image height of the receiving optical path of the transceiver lens at the predetermined field of view angle is within the first threshold range, such that the degree of overlap between the field of view of the laser and the field of view of the detector is greater than the second predetermined threshold. The image height of the transmitting optical path may refer to the distance between the center of the laser emitting the light beam with the certain field of view angle and the principal optical axis of the transmitting optical path. The image height of the receiving optical path may refer to the distance between the center of the detector receiving the echo with the certain field of view angle and the principal optical axis of the receiving optical path. In this way, both the transmitter 1110 and the receiver 1120 can include the uniformly distributed optoelectronic devices, and the field of view of the laser and the field of view of the detector can basically overlap. However, for the detection, it only requires that the field of view of the laser and the field of at least one detector can overlap, and the degree of overlap is greater than the predetermined threshold. As an example, the second predetermined threshold can be between 50% and 90%, for example, 50%, 60%, 80%, or 90%. The values of the first threshold range are related to the focal lengths of the transmitting optical path lens and the receiving optical path lens.

In some embodiments, a ratio of the image height of the transmitting optical path to the image height of the receiving optical path of the transceiver lens at a single predetermined field of view angle is within the first threshold range, such that the degree of overlap between the field of view of the laser and the field of view of the detector is greater than the second predetermined threshold.

In some embodiments, a ratio of the image height of the transmitting optical path to the image height of the receiving optical path of the transceiver lens at multiple predetermined field of view angles is within the first threshold range, such that the degree of overlap between the field of view of the laser and the field of view of the detector is greater than the second predetermined threshold.

In some embodiments, a ratio of the image height of the transmitting optical path to the image height of the receiving optical path of the transceiver lens at each predetermined field of view angle is within the first threshold range, such that the degree of overlap between the field of view of the laser and the field of view of the detector is greater than the second predetermined threshold.

In the embodiments of this disclosure, the transceiver lens 1140 can expand the transmission field of view of the transmitter 1110 and the reception field of view of the receiver 1120, such that the field of view angle of the optical transceiver assembly 1100 is greater than or equal to 140°. The focal length of the transceiver lens 1140 can be less than or equal to 16 mm. Compared to using the moving part to rotate the optical transceiver assembly or using the scanning device to change the propagation direction of the light beam to achieve a larger field of view, this disclosure contemplates using the lens that can expand the field of view to replace the moving part or the scanning device to achieve the LiDAR with the super large field. This can reduce the size requirements for the optoelectronic devices in the LiDAR while expanding the field of view of the LiDAR. In addition, this can also eliminate the additional costs caused by the moving part or the scanning device. In some embodiments of this disclosure, the transceiver lens 1140 may include a meniscus lens. A concave surface of the meniscus lens can face the incident direction of the light beam, while a convex surface faces the incident direction of the echo. The meniscus lens can expand the transmission field of view of the transmitter 1110 and the reception field of view of the receiver 1120, as described above with reference to FIGS. 9 and 10. In some embodiments, the meniscus lens can have the negative optical power, thereby shortening the overall focal length of the transceiver lens 1140.

In some embodiments of this disclosure, the transceiver lens 1140 can expand the transmission field of view of the transmitter 1110 and the reception field of view of the receiver 1120 to make the field of view angle of the optical transceiver assembly greater than or equal to 150°, and the focal length of the transceiver lens 1140 can be less than or equal to 10 mm.

In some embodiments, the beam splitter 1130 may include a partial reflector (e.g., a semi-reflective mirror). The partial reflector transmits at least a portion of the light beam and reflects at least a portion of the echo, or the partial reflector reflects at least a portion of the light beam and transmits at least a portion of the echo. In some embodiments, the beam splitter 1130 may include a mirror with a pinhole, through which at least a portion of the light beam can be transmitted to the transceiver lens, and at least a portion of the echo can be reflected by the mirror to the receiver 1120. In some embodiments, the beam splitter 1130 may include a small mirror, through which at least a portion of the light beam can be reflected to the transceiver lens 1140, and at least a portion of the echo can be transmitted from a periphery of the small mirror to the receiver.

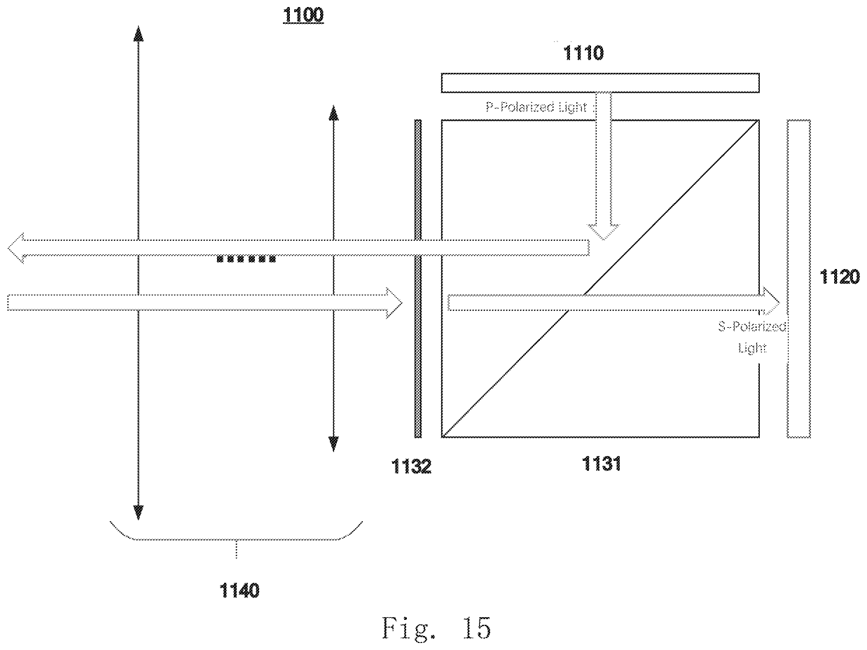

In optional embodiments of this disclosure, the optical transceiver assembly 1100 may use a polarization-based beam splitting manner to reduce energy loss. Specifically, with reference to FIG. 15, the beam splitter may include a polarization beam splitter 1131 for reflecting P-polarized light and transmitting S-polarized light. In addition, the beam splitter may also include a quarter wave plate 1132 located between the polarization beam splitter 1131 and the transceiver lens 1140. In this optional embodiment, a polarization state of the light beam emitted by the transmitter 1110 can be P-polarized, that is, the transmitter 1110 emits the P-polarized light. The P-polarized light can be reflected by the beam splitter 1130 to be guided to the external field of view via the quarter wave plate 1132 and the transceiver lens 1140. The echo returns to the beam splitter 1130 via the transceiver lens 1140 and the quarter wave plate 1132. Since the P-polarized light passes through the quarter wave plate 1132 twice and is converted into the S-polarized light, the echo as the S-polarized light is transmitted by the beam splitter 1130 to the receiver 1120. It should be noted that in some embodiments, the polarization beam splitter 1131 can also transmit the P-polarized light and reflect the S-polarized light. In this case, positions of the transmitter 1110 and the receiver 1120 in FIG. 12 can be interchanged, or the transmitter 1110 can emit the S-polarized light.

The optical transceiver assembly of this disclosure allows for a design of uniformly distributed transmitters/receivers when using a transceiver lens with the distortion.

Optionally, this disclosure can use an f-θ lens that can expand the field of view as the transceiver lens. Due to its inherent distortion, the distortion curves of the transmitting lens and the receiving lens can be designed properly to ensure that the degree of distortion of the transmitting lens and the receiving lens at the edge of the field (corresponding to a larger field of view) is greater than the degree of distortion at the center of the field (corresponding to a smaller field of view). In this way, it can quickly converge the image height at the edge of the lens, thereby avoiding the excessive device size while meeting the requirements of the angular resolution and the field of view of the central field. It can balance the angular resolution and the device size of the central field.

In addition, the LiDAR using the optical transceiver assembly of this disclosure can generate a point cloud that is dense at the center of the field and sparse at the edge of the field. This is because, under some circumstances, the detectors are of uniform size and arranged uniformly. The lens design of this disclosure allows for the greater distortion at the edge of the field of view (to reduce a size of a device). Accordingly, the closer the detector is to the edge field of view, the larger the corresponding field of view angle interval, that is, its corresponding point cloud is sparser. However, the LiDAR typically focuses more on the detection situation of the central field of view. Therefore, the optical transceiver assembly of this disclosure takes advantage of this aspect, enabling the LiDAR to receive a point cloud with a large field of view and that is dense at the central field and sparse at the edge field.

Larger field of view coverage and finer angular resolution are both design objectives of the LiDAR. Given a fixed number of detection channels of the LiDAR, it is difficult to achieve both objectives. Due to its operating environment, a vehicle-mounted LiDAR has detection targets primarily distributed at the central field, and thus requirements for long-distance measurement capability at the central field are higher than requirements at the edge field. Due to a phenomenon that an object appears larger when closer and smaller when farther away, a size of a distant object appears relatively small in the field of the LiDAR. Therefore, to detect a distant object at the central field, it needs to increase a resolution of the central field. Accordingly, how to maintain the larger field of view coverage while increasing the resolution of the central field of the LiDAR is also a technical problem that urgently needs to be solved in the art.

This disclosure further provides an optical transceiver assembly for a LiDAR. The optical transceiver assembly includes a transmitting end and a receiving end. The transmitting end includes a transmitter and a transmitting lens. The transmitter includes a laser array configured to emit a light beam. The receiving end includes a receiving lens and a receiver. The receiver includes a detector array configured to receive an echo. An angular resolution of a first region of a field of the optical transceiver assembly differs from an angular resolution of a second region of the field of the optical transceiver assembly. At least one of the transmitting lens and the receiving lens includes a negative meniscus lens. The optical transceiver assembly for the LiDAR of this disclosure uses the negative meniscus lens as a component in the lens, and uses inherent distortion of a lens group to achieve the densification of the central field and expand the field of view coverage.

As described above with reference to FIG. 1, the optical transceiver assembly 100 for the LiDAR may include the transmitting end 110 and the receiving end 120. The transmitting end 110 may include the transmitter 111. The transmitter 111 may include the laser array that can emit the light beam. The transmitting end 110 may further include the transmitting lens 112. The transmitting lens 112 can guide the light beam to the field of the LiDAR. The receiving end 120 may include the receiver 121 and the receiving lens 122. The receiving lens 122 can guide the echo generated by the reflection of the light beam from the object to the receiver 121. The receiver 121 may include the detector array that can receive the echo.

In some embodiments, an angular resolution of a first region of a field of the optical transceiver assembly 100 can differ from an angular resolution of a second region of the field of the optical transceiver assembly 100. In some embodiments, the second region is closer to an edge of the field of the optical transceiver assembly than the first region. In some other embodiments, the first region is closer to the edge of the field of the optical transceiver assembly than the second region. In some embodiments, the first region can be a central region of the field of the optical transceiver assembly 100, and the second region can be an edge region of the field of the optical transceiver assembly 100. An angular resolution of the central region of the field of the optical transceiver assembly 100 can differ from an angular resolution of the edge region of the field of the optical transceiver assembly 100. The field of view of the optical transceiver assembly 100 can be divided into the central region and the edge region. The central region may refer to a region close to an optical axis, such as a region whose distance from the optical axis is within a specific threshold range. The edge region may refer to a region away from an optical axis, such as a region whose distance from the optical axis is outside a specific threshold range. An angular resolution of the optical transceiver assembly 100 can be characterized as an angle between light beams of adjacent channels.

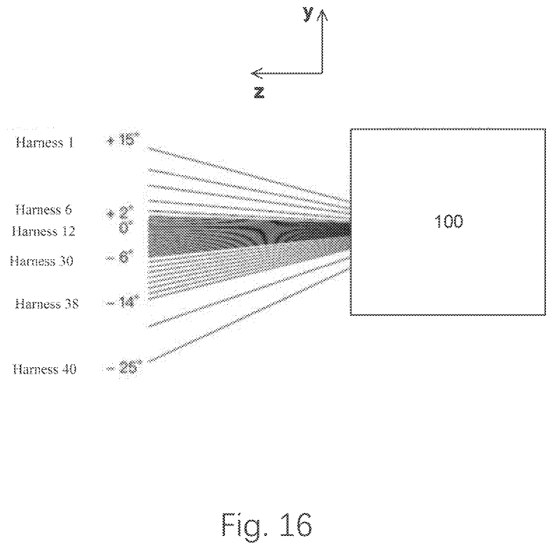

With reference to FIG. 16, it shows an example of the optical transceiver assembly 100 having a non-uniform angular resolution. In some examples, the transmitter 111 may include a laser array composed of 40 lasers. The optical transceiver assembly 100 may emit 40 laser beams in a detection cycle, distributed at different angles in a vertical direction (e.g., y direction), thereby allowing multiple laser beams to detect multiple points in one scanning cycle. In some embodiments, the optical transceiver assembly may emit more or fewer laser beams in a detection cycle. As shown in an example of FIG. 16, the angular resolution of the central region of the field of the optical transceiver assembly 100 is greater than the angular resolution of the edge region of the field of the optical transceiver assembly 100, that is, the laser beams are arranged more densely in a vicinity of a vertical angle of 0° and more sparsely in a region farther from 0°. In this way, the angular resolution of the central region of the LiDAR can be higher, providing more precise target recognition and measurement for the central region. The LiDAR typically focuses on a target in the central region, as the central region is typically located on a vehicle's driving path, there may be other vehicles, pedestrians, road obstacles, and other targets of interest. Accordingly, it is desirable that the central region have a higher detection resolution and a longer detection range. For the edge region, such as a region with an excessively large vertical angle (e.g., sky) or an excessively small vertical angle (e.g., ground), detection priority of the LiDAR is relatively low.

In some embodiments, an angular resolution in a portion of the optical transceiver assembly 100 can be uniform, while an angular resolution in another portion can be non-uniform. In an example of FIG. 16, laser beams 6 to 30 can be set such that a vertical angular resolution between adjacent two laser beams is a first predetermined value, laser beams 5 to 6 and 30 to 38 can be set such that a vertical angular resolution of adjacent two laser beams is a second predetermined value, and other laser beams can be set to non-uniform distribution. In other embodiments, the angular resolution of the central region of the optical transceiver assembly 100 can be uniform and the angular resolution of the edge region may also be uniform, but the angular resolution of the central region is greater than the angular resolution of the edge region.

Through the above method, it can achieve non-uniform distribution of angular resolutions across multiple regions of the field of the optical transceiver assembly 100. In some embodiments, each of the multiple regions may include one or more channels/light beams. It should be noted that FIG. 16 merely shows an example where the angular resolution of the central region of the field of the optical transceiver assembly 100 is different from the angular resolution of the edge region of the field of the optical transceiver assembly 100. A method of differentiating the angular resolution of the central region and the edge region of the field provided in this disclosure is not limited thereto. Those skilled in the art can conceive of various non-uniform distribution manners for the angular resolutions based on teachings of this disclosure.

Setting the negative meniscus lens in the lens can assist in achieving the non-uniform distribution of the angular resolutions, and at least one of the transmitting lens 112 and the receiving lens 122 may include the negative meniscus lens.

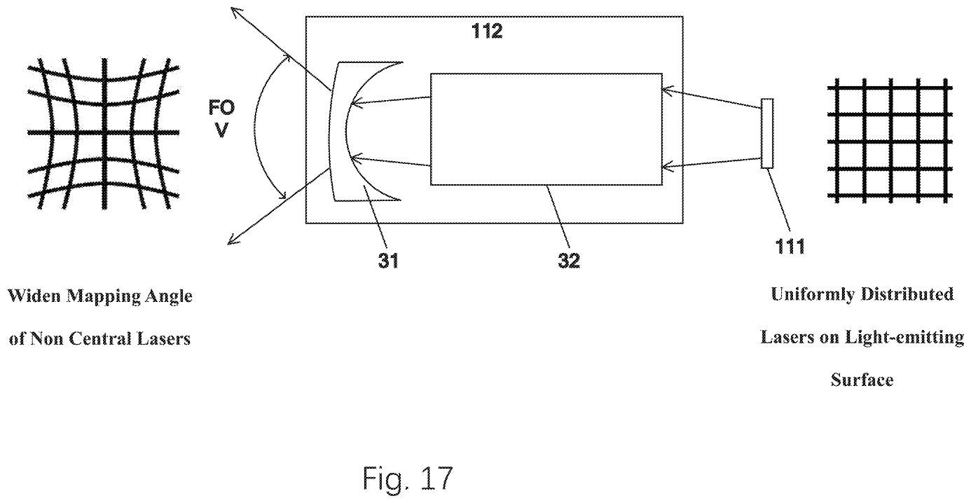

In some embodiments of this disclosure, the transmitting lens 112 may include at least one negative meniscus lens 31 to expand the field of view of the transmitter 111, as shown in FIG. 17. Those skilled in the art can understand that the transmitting lens 112 may further include a transmitting main lens group 32. The transmitting main lens group can shape (e.g., collimate) the laser beam emitted by the transmitter 111. In this way, the transmitting lens 112 may have the pincushion distortion, which can be configured to twist the light-emitting surface that the lasers are distributed uniformly into the surface with the center dense and edge sparse structure, as shown in FIG. 17. In some embodiments, the laser at the edge channel can correspond to the larger field of view angle in the space, while the laser at the central channel is less affected by the distortion of the transmitting lens 112, and more pixels can be applied to the central field, maintaining the higher pixel density in the central field and increasing the angular resolution of the central region of the field. In a case that the laser array in the transmitter 111 includes multiple uniformly distributed lasers, the transmitting end 110 can achieve the larger field of view coverage and the densification of the central field. As shown in FIG. 2, the laser array in the transmitter 111 can be arranged in a one-dimensional or two-dimensional array, with multiple lasers distributed uniformly in a row/column direction.

In some embodiments, a concave surface of the negative meniscus lens 31 may face an incident direction of the light beam.

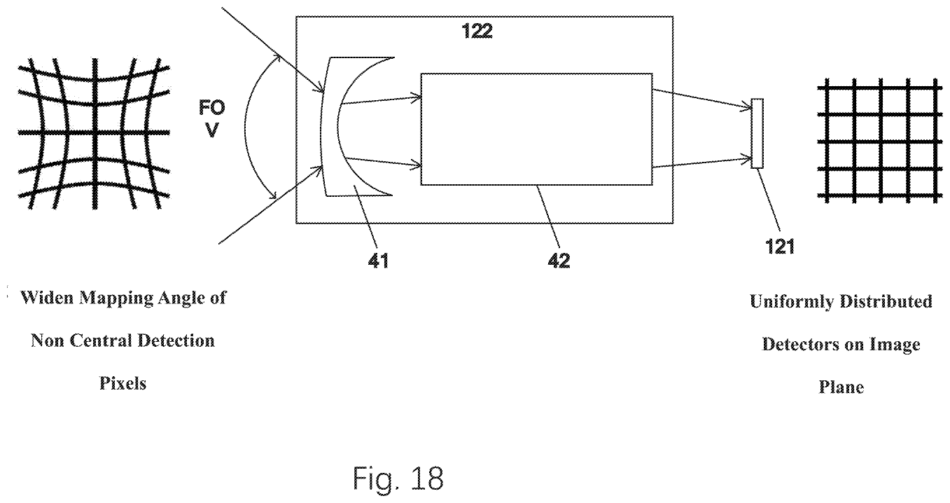

In some embodiments of this disclosure, the receiving lens 122 may include at least one negative meniscus lens 41 to expand the field of view of the receiver 121, as shown in FIG. 18. Those skilled in the art can understand that the receiving lens 122 may further include a receiving main lens group 42. The receiving main lens group can guide the echo to the receiver 121. In this way, the receiving lens 122 can have the pincushion distortion, which can twist the photosensitive surface that the detectors are distributed uniformly into the surface with the center dense and edge sparse structure, as shown in FIG. 18. In some embodiments, the detector at the edge channel can correspond to the larger field of view angle in the space, while the detector at the central channel is less affected by the distortion of the receiving lens 122, and more pixels can be applied to the central field, maintaining the higher pixel density and achieving the relatively high resolution at the central field. In a case that the detector array in the receiver 121 includes multiple uniformly distributed detectors, the receiving end 120 can achieve the larger field of view coverage and the densification of the central field. As shown in FIG. 3, the detector array in the receiver 121 can be arranged in the one-dimensional or two-dimensional array, with the multiple detectors distributed uniformly in the row/column direction.

In some embodiments, a convex surface of the negative meniscus lens 41 can face an incident direction of the echo.

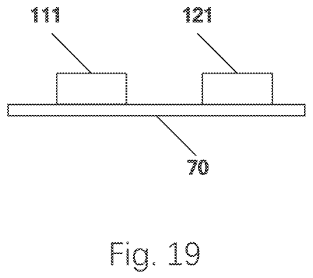

In some embodiments of this disclosure, With reference to FIG. 19, the transmitter 111 and the receiver 121 can be provided on a same circuit board 70, thereby fixing relative positions of the transmitter 111 and the receiver 121. This setting method is conducive to reducing design complexity and installation and adjustment difficulty of the transmitting lens 112 and the receiving lens 122, as there is no need to consider a change in relative positions between the transmitter 111 and the receiver 121 during design.

In some embodiments of this disclosure, a transceiver end (the transmitting end 110 and the receiving end 120) of the optical transceiver assembly 100 may both use a lens design that includes a negative meniscus lens, or alternatively, only one end (the transmitting end/the receiving end) may use the lens design that includes the negative meniscus lens, while the other end (the receiving end/the transmitting end) uses a design that includes the lens without the negative meniscus lens and the non-uniformly distributed optoelectronic devices.

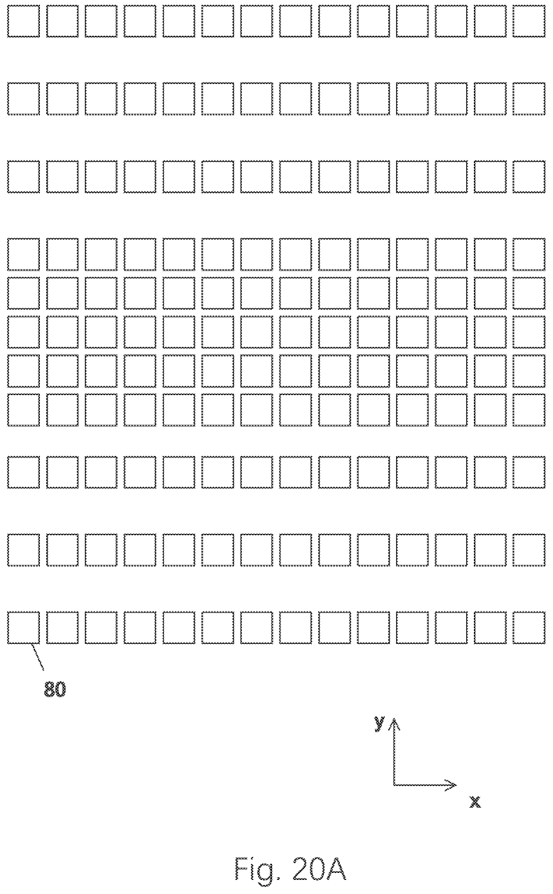

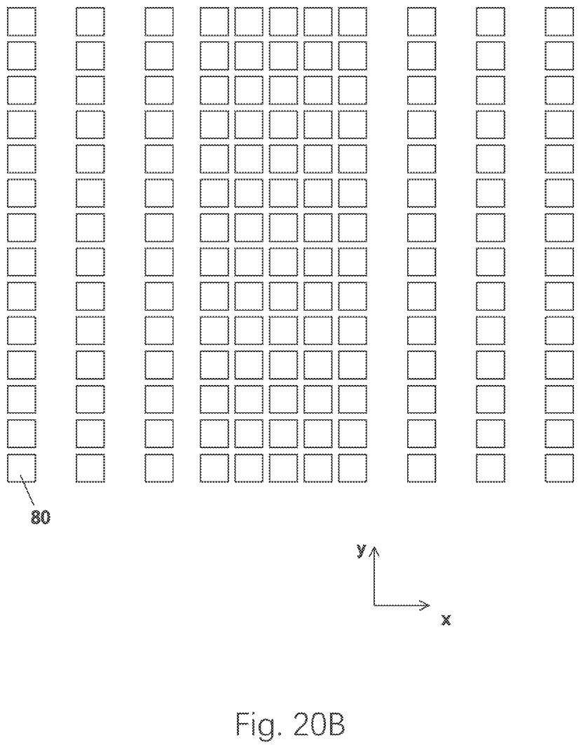

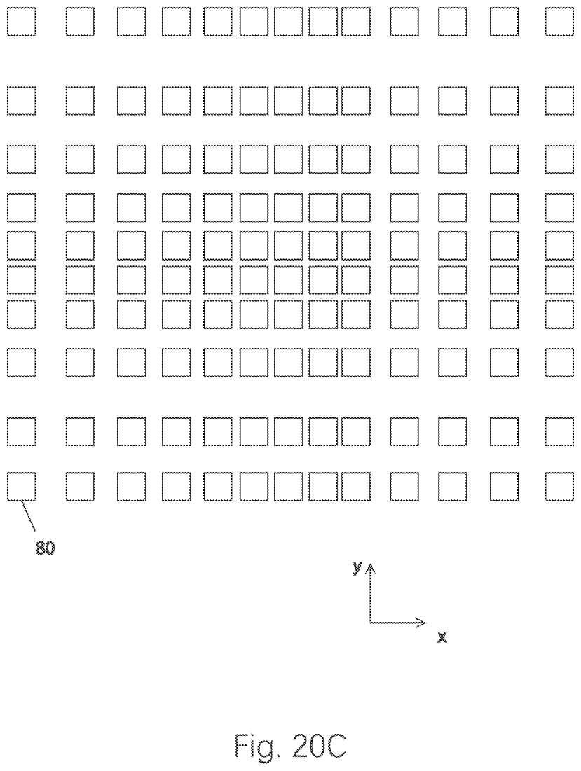

As an example, when the transmitting end 110 uses a design that includes the transmitting lens with the negative meniscus lens and the laser array with the uniformly distributed lasers, the receiving end 120 may use a design that includes the receiving lens without the negative meniscus lens and the detector array with the non-uniformly distributed detectors. With reference to FIGS. 20A and 20C, the detector array with the non-uniformly distributed detectors may include multiple detectors 80 non-uniformly distributed along the first direction (e.g., y direction). With reference to FIGS. 20B and 20C, in some embodiments, the multiple detectors 80 may also be non-uniformly distributed along the second direction (e.g., x direction). The second direction is different from the first direction, for example, it can be perpendicular to the first direction. An angular resolution of a third region of the detector array can be different from an angular resolution of a fourth region of the detector array. In some embodiments, the fourth region is closer to an edge of the detector array than the third region. In some other embodiments, the third region is closer to the edge of the detector array than the fourth region. In some embodiments, the third region can be a central region of the detector array, and the fourth region can be an edge region of the detector array. In examples shown in FIGS. 20A to 20C, a density of the detectors in the central region of the detector array is greater than a density of the detectors in the edge region of the detector array.

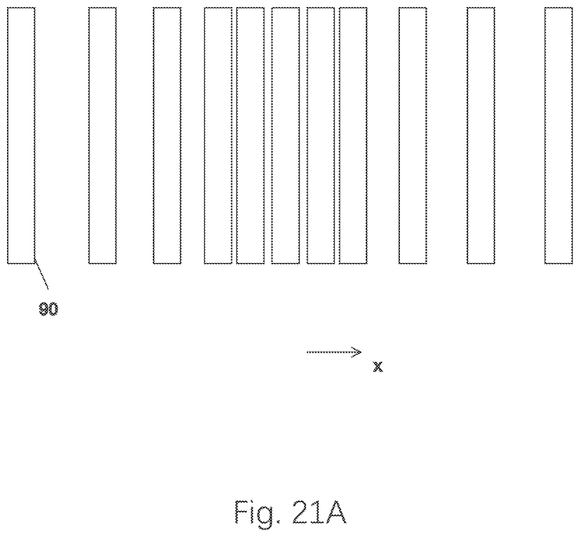

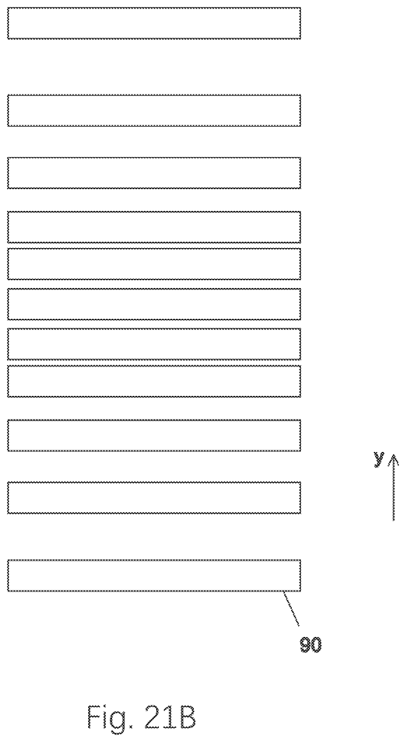

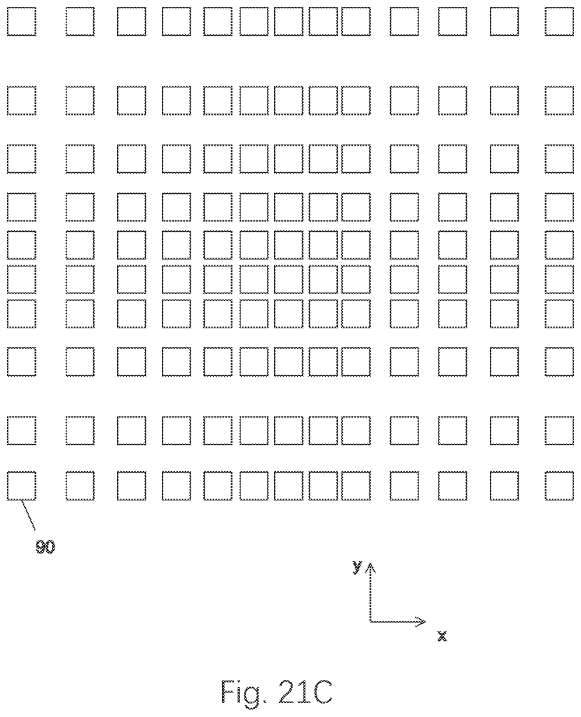

As another example, when the receiving end 120 uses a design that includes the receiving lens with the negative meniscus lens and the detector array with the uniformly distributed detectors, the transmitting end 110 may use a design that includes the transmitting lens without the negative meniscus lens and the laser array with the non-uniformly distributed lasers. With reference to FIGS. 21A and 21B, the laser array with the non-uniformly distributed lasers may include multiple lasers 90 non-uniformly distributed along the first direction (e.g., y direction) or the second direction (e.g., x direction). With reference to FIG. 21C, in some embodiments, when the laser array is the two-dimensional array, the multiple lasers can be distributed non-uniformly along both the first direction and the second direction (e.g., x direction and y direction). The second direction is different from the first direction, for example, it can be perpendicular to the first direction. An angular resolution of a fifth region of the laser array can be different from an angular resolution of a sixth region of the laser array. In some embodiments, the sixth region is closer to an edge of the laser array than the fifth region. In some other embodiments, the fifth region is closer to the edge of the laser array than the sixth region. In some embodiments, the fifth region can be a central region of the laser array, and the sixth region can be an edge region of the laser array. In examples shown in FIGS. 21A to 21C, a density of the lasers in the central region of the laser array is greater than a density of the lasers in the edge region of the laser array.

In some embodiments of this disclosure, through a mutual cooperation between device arrangement and lens design in the transmitting end 110 and the receiving end 120, a light spot emitted by one laser in the laser array can at least overlap partially with a field of at least one detector in the detector array. Therefore, it can ensure a corresponding relationship between the field of view of the laser and the field of view of the detector of the LiDAR, improving detection accuracy.

In some embodiments of this disclosure, the transmitting lens or the receiving lens includes at least one of the following: a wide-angle lens or a fisheye lens. This can achieve expansion of at least one of a horizontal field of view or a vertical field of view of the LiDAR. For example, it can be expanded to greater than 140°, greater than 150°, greater than 160°, greater than 170°, greater than 180° or even larger.

In some embodiments of this disclosure, the optical transceiver assembly 100 may further include a homogenizer provided on an optical path of the transmitting end 110. The homogenizer can cooperate with a one-dimensional laser array or an elongated two-dimensional laser array to achieve a transmission effect of the laser array as shown in FIG. 2. The elongated two-dimensional laser array can include M rows (x direction) and N columns (y direction) of lasers, where M is much larger than N or much smaller than N.

In some embodiments, the homogenizer can be located on a light exit side of the transmitting lens 112, such that the transmitter 111, the transmitting lens 112, and the homogenizer can be freely adjusted to receive desired light field distribution. Optionally, the homogenizer can be located near an aperture inside the transmitting lens 112. For example, the homogenizer can be integrated with the transmitting lens 112. Therefore, the homogenizer and the transmitting lens 112 as a whole can be relatively adjusted with respect to the transmitter 111 to receive the desired light field distribution. In some embodiments, the homogenizer can be located on a light exit side of the transmitter 111. For example, the homogenizer can be integrated with the transmitter 111. Therefore, the homogenizer and the transmitter 111 as a whole can be relatively adjusted with respect to the transmitting lens 112 to receive the desired light field distribution. In some embodiments, the homogenizer can be located between the transmitter 111 and the transmitting lens 112, and the three are independent of one another. The transmitter 111, the transmitting lens 112, and the homogenizer can be freely adjusted to receive the desired light field distribution. For example, free adjustment can include changing spacing between any two of these components or adjusting angles of these components relative to each other, or the like.

As an example, the homogenizer may include but is not limited to: a diffuser, a microlens array, a diffractive optical element (“DOE”), an optical waveguide, or the like.

In some embodiments of this disclosure, the transmitting end can use various types of lasers, including but not limited to the vertical cavity surface-emitting laser (“VCSEL”), the edge-emitting laser (“EEL”), or the like. The receiving end can use various types of detectors, including but not limited to the single photon avalanche diode (“SPAD”), the avalanche photodiode (“APD”), the silicon photomultiplier (“SiPM”), or the like.

The angular resolution of the first region of the field of view of the optical transceiver assembly of this disclosure differs from the angular resolution of the second region of the field of view of the optical transceiver assembly, and at least one of the transmitting lens and the receiving lens is designed to include the negative meniscus lens. Therefore, it can achieve the densification of the central field of the LiDAR and the expansion of the field of view coverage by using the inherent distortion of the lens. In addition, as the degree of integration of the optoelectronic devices increases, such as the chipization of the transmitting end and the receiving end, the transmitting end/receiving end devices have become the integrated devices. For the IC design, the uniformly distributed lasers/detectors and processing circuits are an economical and less complex solution. Therefore, this disclosure provides an approach using the inherent distortion of the lens to achieve the densification of central channels.

Based on another example embodiment of this disclosure, a LiDAR is further provided.

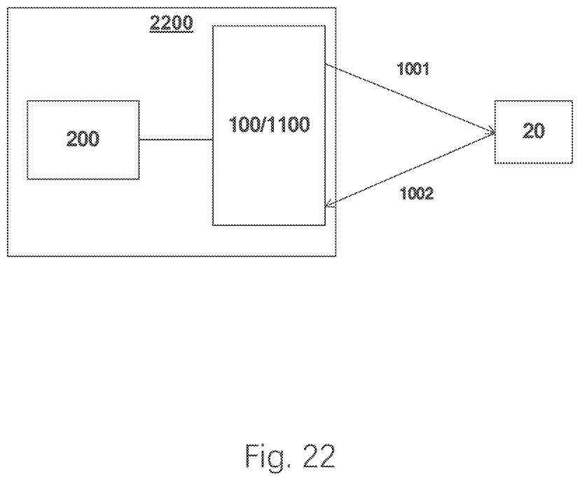

As shown in FIG. 22, a LiDAR 2200 may include the optical transceiver assembly 100, the optical transceiver assembly 1100, and the controller 200 described above.

The transmitting end 110 in the optical transceiver assembly 100 and the optical transceiver assembly 1100 can provide a light beam 1001 into the space to illuminate an object 20 in the space. At least a portion of the light beam 1001 is reflected from the object 20 to generate an echo 1002, and at least a portion of optical signals (e.g., photons) of the echo 1002 is collected by the receiving end 120.

The controller 200 is connected to the optical transceiver assembly 100 and can control the transmitting end 110 to emit the light beam and determine at least one of a distance and a reflectivity of the object 20 based at least on the echo received by the receiving end 120.

In some embodiments of this disclosure, the controller 200 can also control multiple lasers of a transmitter to emit light simultaneously or in a time-division manner.

As an example, the controller 200 may include but is not limited to: a central processing unit (“CPU”), a field programmable gate array (“FPGA”), a digital signal processing (“DSP”), and other chips.

Based on yet another exemplary embodiment of this disclosure, terminal equipment is further provided. The terminal equipment may include the LiDAR 2200 as described above. The terminal equipment can be a vehicle (e.g., a smart car), surveying equipment, aircraft (e.g., a drone), a ship, or the like.

It should be understood that the above illustration is illustrative rather than restrictive. For example, at least one of the above embodiments or aspects thereof can be used in combination with each other. In addition, many modifications can be made without departing from a scope of this disclosure to adapt specific situations or materials to teachings of various embodiments of this disclosure. Although sizes and types of materials described in this disclosure are configured to limit parameters of various embodiments of this disclosure, various embodiments are not meant to be restrictive, but rather exemplary. Many other embodiments are apparent to those skilled in the art upon reading the above illustration. Accordingly, scopes of various embodiments of this disclosure should be determined with reference to appended claims and a full scope of equivalent forms sought for protection by these claims.

1. An optical transceiver assembly for a LiDAR, comprising:
a transmitting end, comprising:
a transmitter, comprising a laser, wherein the transmitter is configured to emit a light beam; and
a transmitting lens, configured to shape the light beam and guide the light beam to an external field of view; and
a receiving end, comprising:
a receiving lens, configured to transmit an echo generated by reflection of the light beam from an object to a receiver; and
a receiver, comprising a detector, wherein the receiver is configured to receive the echo and generate an electrical signal;
wherein a ratio of an image height of a transmitting lens to an image height of the receiving lens at a predetermined field of view angle is within a first threshold range, a degree of overlap between a field of view of the laser and a field of view of the detector is greater than a second predetermined threshold.

2. The optical transceiver assembly of claim 1, wherein the second predetermined threshold is 50%, 60%, 80%, or 90%.

3. The optical transceiver assembly of claim 1, wherein a field of view angle of the transmitting end is greater than or equal to 140°, a field of view angle of the receiving end is greater than or equal to 140°, a focal length of the transmitting lens is less than or equal to 16 mm, and a focal length of the receiving lens is less than or equal to 16 mm.

4. The optical transceiver assembly of claim 3, wherein the transmitting lens comprises at least a first meniscus lens located on a light exit side, a concave surface of the first meniscus lens faces the transmitter, and the first meniscus lens has a negative optical power.

5. The optical transceiver assembly of claim 3, wherein the receiving lens comprises at least a second meniscus lens located on a light incident side, a concave surface of the second meniscus lens faces the receiver, and the second meniscus lens has a negative optical power.

6. The optical transceiver assembly of claim 3, wherein at least one of a horizontal field of view angle or a vertical field of view angle at the transmitting end is less than 180°, and at least one of a horizontal field of view angle or a vertical field of view angle at the receiving end is less than 180°.

7. The optical transceiver assembly of claim 6, wherein the horizontal field of view angle of the transmitting end is greater than 180°, the horizontal field of view angle of the receiving end is greater than 180°, and the transmitting lens and the receiving lens are arranged vertically.

8. The optical transceiver assembly of claim 6, wherein the vertical field of view angle of the transmitting end is greater than 180°, the vertical field of view angle of the receiving end is greater than 180°, and the transmitting lens and the receiving lens are arranged horizontally.

9. The optical transceiver assembly of claim 3, wherein a degree of distortion of the transmitting lens or a degree of distortion of the receiving lens at an edge of a field is greater than a degree of distortion at a center of the field.

10. The optical transceiver assembly of claim 3, wherein the field of view angle of the transmitting end is greater than or equal to 150°, the field of view angle of the receiving end is greater than or equal to 150°, and the focal length of the transmitting lens is less than or equal to 10 mm, and the focal length of the receiving lens is less than or equal to 10 mm.

11. The optical transceiver assembly of claim 1, wherein the focal length of the transmitting lens is smaller than the focal length of the receiving lens.

12.-16. (canceled)

17. An optical transceiver assembly for a LiDAR, comprising:
a transmitting end, comprising:
a transmitter, comprising a laser array configured to emit a light beam; and
a transmitting lens;
a receiving end, comprising:
a receiving lens; and
a receiver, comprising a detector array configured to receive an echo;
wherein an angular resolution of a first region of a field of the optical transceiver assembly differs from an angular resolution of a second region of the field of the optical transceiver assembly, and at least one of the transmitting lens or the receiving lens comprises a negative meniscus lens.

18. The optical transceiver assembly of claim 17, wherein the second region is closer to an edge of the field of the optical transceiver assembly than the first region.

19. (canceled)

20. The optical transceiver assembly of claim 17, wherein the transmitting lens comprises a first negative meniscus lens, and the laser array comprises a plurality of lasers that are distributed uniformly.

21. (canceled)

22. The optical transceiver assembly of claim 17, wherein the detector array comprises a plurality of detectors that are distributed non-uniformly along a first direction.

23. The optical transceiver assembly of claim 22, wherein the plurality of detectors are distributed non-uniformly along a second direction, and the second direction differs from the first direction.

24.-25. (canceled)

26. The optical transceiver assembly of claim 17, wherein the receiving lens comprises a second negative meniscus lens, and the detector array comprises a plurality of detectors that are distributed uniformly.

27.-32. (canceled)

33. The optical transceiver assembly of claim 17, wherein the transmitting lens or the receiving lens comprises at least one of the following: a wide-angle lens or a fisheye lens.

34. (canceled)

35. A LiDAR, comprising:
the optical transceiver assembly described in claim 1; and
a controller, configured to
control the transmitter to emit the light beam, and
determine at least one of a distance and a reflectivity of an object based on the echo received by the receiver.

36. The LiDAR of claim 35, wherein the controller is further configured to control the plurality of lasers of the transmitter to emit light simultaneously or in a time-division manner.

37. (canceled)
